(19) United States
(12) Patent Application Publication
(10) Pub. No.: US 2026/0004772 A1
(43) Pub. Date: Jan. 1, 2026

(54) TECHNIQUES FOR ENHANCING SPEECH LANGUAGE MODELS USING DESCRIPTIVE SPEECH-TEXT ALIGNMENT

(71) Applicant: NVIDIA CORPORATION, Santa Clara, CA (US)

(72) Inventors: Szu-Wei FU, Keelung (TW); Yu-Chiang WANG, Taipei (TW); Zhehuai CHEN, Odessa, FL (US); He HUANG, Greenville, SC (US); Boris GINSBURG, Sunnyvale, CA (US)

(21) Appl. No.: 19/047,461

(22) Filed: Feb. 6, 2025

Related U.S. Application Data
(60) Provisional application No. 63/664,423, filed on Jun. 26, 2024.

(51) Int. Cl. G10L 15/06; G10L 15/183

(52) U.S. Cl. CPC G10L 15/063; G10L 15/183

(57) ABSTRACT

The disclosed method for generating a first depth map for responding to audio input includes processing the audio input using a trained encoder to generate a representation of the audio input, where the audio input includes speech; processing the representation of the audio input using a first trained adapter to generate one or more features; and processing the one or more features and text associated with the audio input using a trained language model to generate a response.

### CROSS-REFERENCE TO RELATED APPLICATIONS

This application claims priority benefit of the United States Provisional Patent Application titled, “ENHANCING SPEECH LANGUAGE MODELS THROUGH DESCRIPTIVE SPEECH-TEXT ALIGNMENT,” filed on Jun. 26, 2024 and having Ser. No. 63/664,423. The subject matter of this related application is hereby incorporated herein by reference.

### BACKGROUND

### Technical Field

Embodiments of the present disclosure relate generally to computer science, artificial intelligence, and machine learning, and more specifically, to techniques for enhancing speech language models using descriptive speech-text alignment.

### Description of the Related Art

In machine learning, speech language models are a type of machine learning model designed to process and understand natural language in the form of audio input that includes speech, which is referred to herein as “speech audio.” Speech language models have been used in applications such as digital voice assistants, transcription services, automatic speech recognition systems, and real-time translation.

Conventional speech language models combine speech recognition and natural language processing techniques to interpret and respond to speech audio. A speech language model typically begins with speech recognition, which involves using a speech model to convert an audio signal, composed of sound waves, into text. Once the speech audio has been transcribed into text, a language model can process the text to understand the context, structure, and meaning of the words, phrases, and sentences within the text. Then, the language model can generate a response, such as an answer to a question within the text.

One drawback of the above approach is that, sometimes, the transcribed text does not accurately correspond to the words being spoken in the speech audio. For example, the transcribed text can be inaccurate when the speech audio deviates from training data that was used to train the speech model within the speech language model, such as when the speech audio includes unclear speech, accents, technical jargon, emotional tones, speaking speed, or unusual pronunciations that result in complex or non-standard speech patterns that the speech model was not trained to understand. When the transcribed text is not accurate, the language model that processes the transcribed text can generate text outputs that, while responding to the inaccurately transcribed text, are incorrect or irrelevant responses to the original speech audio. For example, the language model could fail to understand a question within the speech audio that is not transcribed accurately. In such a case, the language model can generate an incorrect or irrelevant answer to the question.

As the foregoing illustrates, what is needed in the art are more effective speech language models.

### SUMMARY

One embodiment of the present disclosure sets forth a computer-implemented method for responding to audio input. The method includes processing the audio input using a trained encoder to generate a representation of the audio input, where the audio input includes speech. The method further includes processing the representation of the audio input using a first trained adapter to generate one or more features. In addition, the method includes processing the one or more features and text associated with the audio input using a trained language model to generate a response.

Another embodiment of the present disclosure sets forth a computer-implemented method for training a speech language model. The method includes generating a set of text captions based on meta information associated with a first set of audio that includes speech, wherein the meta information specifies at least one of a speaking style or speaker information associated with the speech included in the first set of audio. The method further includes performing, using the first set of audio and the set of text captions, one or more first operations to train a speech language model to generate a text caption for first input audio that includes speech.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that, with the disclosed techniques, a speech language model can be trained to account for context, such as the speed and emotional tone of speech and the gender of a speaker, in speech audio. By considering both the context of speech within the speech audio and the text that is transcribed from the speech audio, the disclosed techniques can mitigate the effects of the text being transcribed inaccurately. That is, even when the transcribed text is inaccurate due to complex or non-standard speech patterns that a speech model in the speech language model was not trained to understand, the speech language mode is able to generate more correct and relevant responses that adjust for the inaccuracies in the transcription. In particular, the disclosed techniques can generate more correct and relevant responses to speech audio than is possible with conventional speech language models that rely solely on the transcribed text. For example, the disclosed techniques can be used to generate answers to questions in speech audio that are more accurate than answers generated by conventional speech language models. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a computer-based system configured to implement one or more aspects of the various embodiments;

FIG. 2 is a more detailed illustration of the machine learning server of FIG. 1, according to various embodiments;

FIG. 3 is a more detailed illustration of the computing device of FIG. 1, according to various embodiments;

FIG. 4 is a more detailed illustration of the model trainer of FIG. 1, according to various embodiments;

FIG. 5 is a more detailed illustration of the speech caption generator of FIG. 4, according to various embodiments;

FIG. 6 is a more detailed illustration of the speech application of FIG. 1, according to various embodiments;

FIG. 7 is a flow diagram of method steps for training a speech language model, according to various embodiments; and

FIG. 8 is a flow diagram of method steps for processing speech audio using a trained speech language model, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### General Overview

Embodiments of the present disclosure provide techniques for training and using a speech language model to respond to audio of speech. In some embodiments, the speech language model includes a speech model that is trained to convert speech audio into natural language transcriptions, a language model that is trained to answer questions, and a modality adapter that is trained to generate speech features from a latent representation output by an encoder of the speech language model. Given speech audio as input, the encoder of the speech model encodes the speech audio to generate the latent representation. The latent representation is then input into the modality adapter, which generates the speech features, and a decoder of the speech model, which generates a natural language text transcription of the speech. The speech features, the transcription, and a text prompt (e.g., asking the language model to answer a question) are then input into the language model, which outputs a natural language response.

In some embodiments, the speech language model is trained in two stages. In a first stage of the training, the speech language model is trained using speech audio, as well as the text prompts and associated speech captions that are generated to describe meta information associated with the speech audio in different ways. Specifically, the speech language model is trained to take as input the speech audio and to output speech captions. In a second stage of the training, the speech language model is trained using question-answer data that includes speech audio of users asking questions and natural language text answers to the questions. Specifically, the speech language model is trained to take as input the speech audio and to output responses to the speech audio.

The techniques for training and using a speech language model described herein have many real-world applications. For example, those techniques could be applied to train a speech language model that is used in a digital voice assistant, a transcription service, an automatic speech recognition system, or a real-time translation system. As another example, those techniques could be applied to train a speech language model that is deployed in a mobile device, an automobile, or a smart home device.

The above examples are not in any way intended to be limiting. As persons skilled in the art will appreciate, as a general matter, the techniques for training and using a speech language model described herein can be implemented in any suitable application.

### System Overview

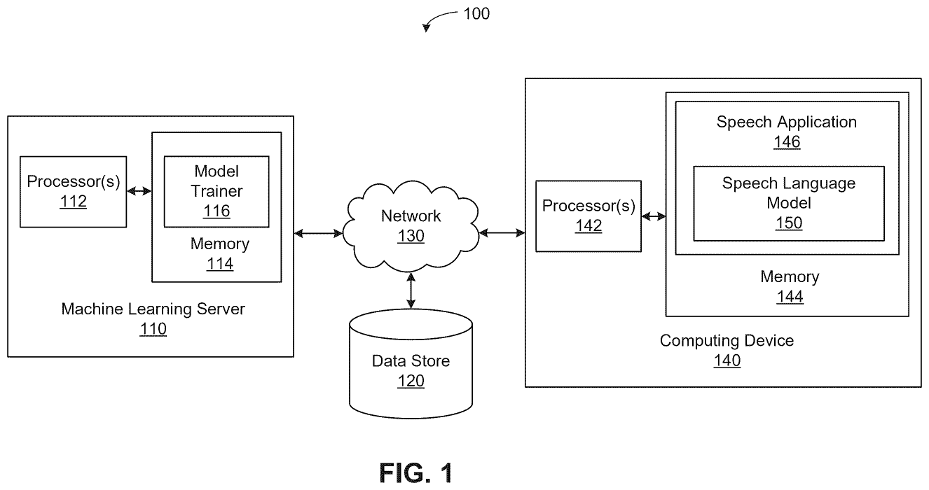

FIG. 1 illustrates a block diagram of a computer-based system 100 configured to implement one or more aspects of at least one embodiment. As shown, the system 100 includes a machine learning server 110, a data store 120, and a computing device 140 in communication over a network 130, which can be a wide area network (WAN) such as the Internet, a local area network (LAN), a cellular network, and/or any other suitable network.

As shown, a model trainer 116 executes on one or more processors 112 of the machine learning server 110 and is stored in a system memory 114 of the machine learning server 110. The processor 112 receives user input from input devices, such as a keyboard or a mouse. In operation, the one or more processors 112 may include one or more primary processors of the machine learning server 110, controlling and coordinating operations of other system components. In particular, the processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

The system memory 114 of the machine learning server 110 stores content, such as software applications and data, for use by the processor(s) 112 and the GPU(s) and/or other processing units. The system memory 114 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace the system memory 114. The storage can include any number and type of external memories that are accessible to the processor 112 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

The machine learning server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in the system memory 114 can be modified as desired. Further, the connection topology between the various units in FIG. 1 can be modified as desired. In some embodiments, any combination of the processor(s) 112, the system memory 114, and/or GPU(s) can be included in and/or replaced with any type of virtual computing system, distributed computing system, and/or cloud computing environment, such as a public, private, or a hybrid cloud system.

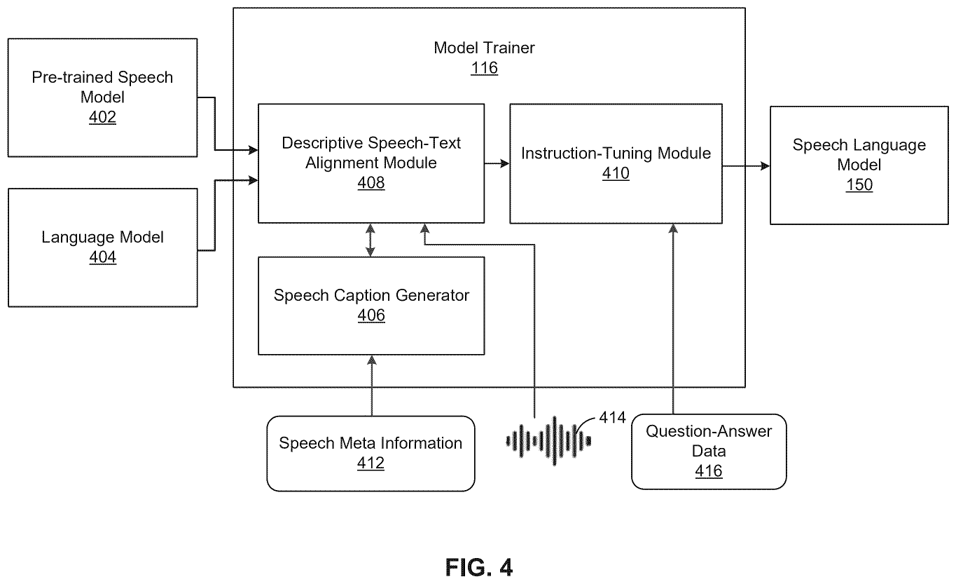

In some embodiments, the model trainer 116 is configured to train one or more machine learning models, including a speech language model 150 that is trained to respond to audio that includes speech, as discussed in greater detail below in conjunction with FIGS. 4-5 and 7. Training data and/or trained machine learning models, including the speech language model, can be stored in the data store 120. In some embodiments, the data store 120 can include any storage device or devices, such as fixed disc drive(s), flash drive(s), optical storage, network attached storage (NAS), and/or a storage area-network (SAN). Although shown as accessible over the network 130, in at least one embodiment the machine learning server 110 can include the data store 120.

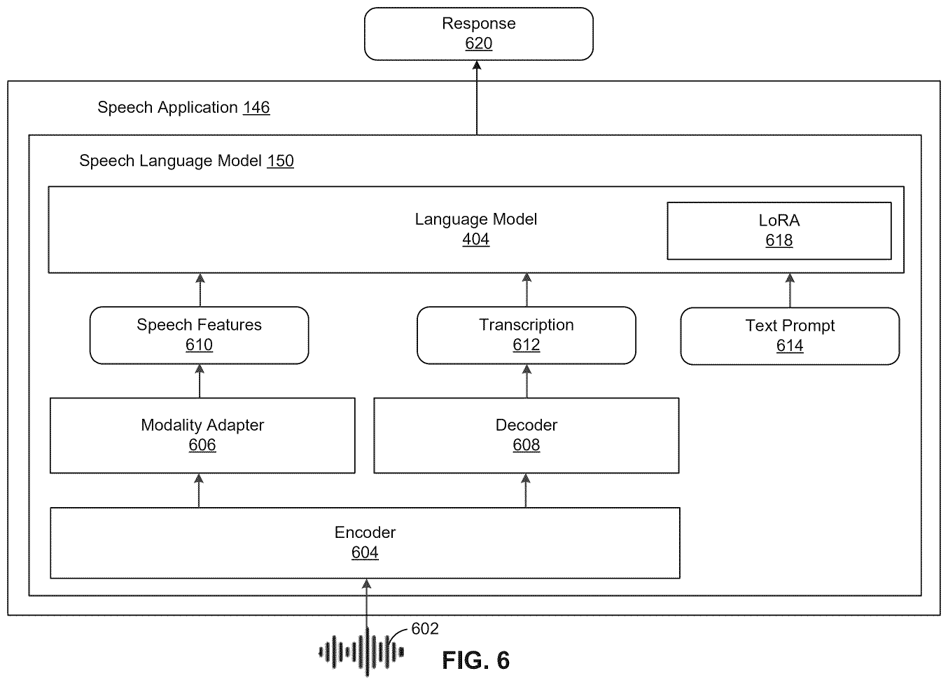

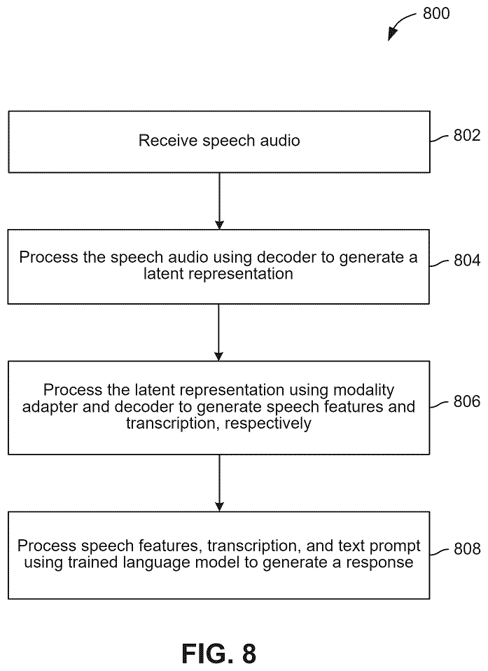

As shown, a speech application 146 that uses the trained speech language model 150 is stored in memory 144, and executes on processor(s) 142, of the computer device 140. The memory 144 and the processor(s) 142 can be similar to the memory 114 and the processor(s) of the machine learning server 110, described above. The speech application 146 is discussed in greater detail below in conjunction with FIGS. 6 and 8.

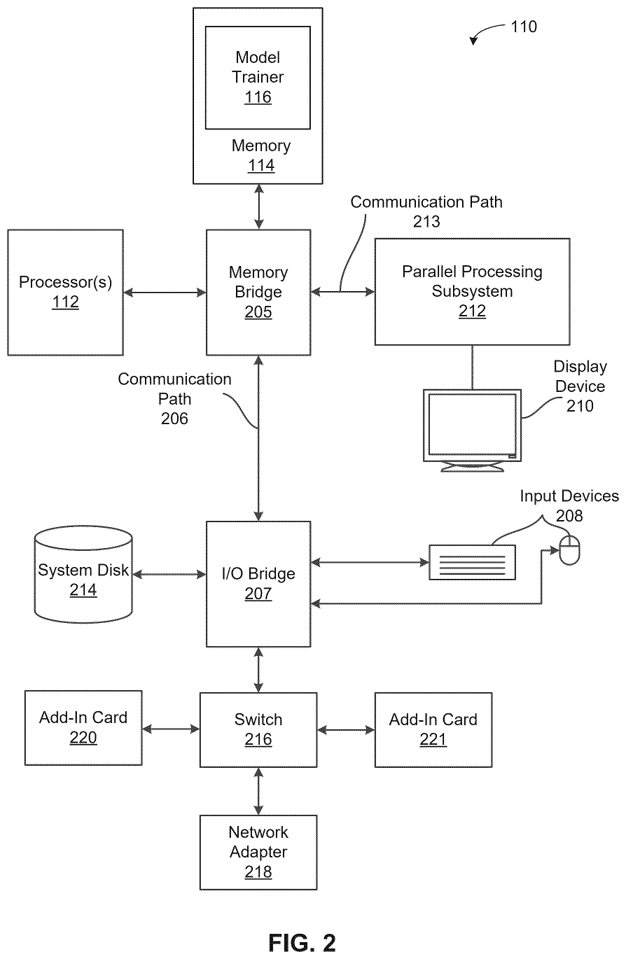

FIG. 2 is a block diagram illustrating the machine learning server 110 of FIG. 1 in greater detail, according to various embodiments. The machine learning server 110 may include any type of computing system, including, without limitation, a server machine, a server platform, a desktop machine, a laptop machine, a hand-held/mobile device, a digital kiosk, an in-vehicle infotainment system, and/or a wearable device. In some embodiments, the machine learning server 110 is a server machine operating in a data center or a cloud computing environment that provides scalable computing resources as a service over a network.

In various embodiments, the machine learning server 110 includes, without limitation, the processor(s) 112 and the memory (ies) 114 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In one embodiment, I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to the processor(s) 112 for processing. In some embodiments, the machine learning server 110 may be a server machine in a cloud computing environment. In such embodiments, machine learning server 110 may not include input devices 208, but may receive equivalent input information by receiving commands (e.g., responsive to one or more inputs from a remote computing device) in the form of messages transmitted over a network and received via the network adapter 218. In some embodiments, switch 216 is configured to provide connections between I/O bridge 207 and other components of the machine learning server 110, such as a network adapter 218 and various add-in cards 220 and 221.

In some embodiments, I/O bridge 207 is coupled to a system disk 214 that may be configured to store content and applications and data for use by processor(s) 142 and parallel processing subsystem 212. In one embodiment, system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 207 as well.

In various embodiments, memory bridge 205 may be a Northbridge chip, and I/O bridge 207 may be a Southbridge chip. In addition, communication paths 206 and 213, as well as other communication paths within machine learning server 110, may be implemented using any technically suitable protocols, including, without limitation, AGP (Accelerated Graphics Port), HyperTransport, or any other bus or point-to-point communication protocol known in the art.

In some embodiments, parallel processing subsystem 212 comprises a graphics subsystem that delivers pixels to an optional display device 210 that may be any conventional cathode ray tube, liquid crystal display, light-emitting diode display, and/or the like. In such embodiments, the parallel processing subsystem 212 may incorporate circuitry optimized for graphics and video processing, including, for example, video output circuitry. Such circuitry may be incorporated across one or more parallel processing units (PPUs), also referred to herein as parallel processors, included within the parallel processing subsystem 212.

In some embodiments, the parallel processing subsystem 212 incorporates circuitry optimized (e.g., that undergoes optimization) for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and/or compute processing operations. System memory 114 includes at least one device driver configured to manage the processing operations of the one or more PPUs within parallel processing subsystem 212. In addition, the system memory 114 includes the model trainer 116. Although described herein primarily with respect to the model trainer 116, techniques disclosed herein can also be implemented, either entirely or in part, in other software and/or hardware, such as in the parallel processing subsystem 212.

In various embodiments, parallel processing subsystem 212 may be integrated with one or more of the other elements of FIG. 2 to form a single system. For example, parallel processing subsystem 212 may be integrated with processor 142 and other connection circuitry on a single chip to form a system on a chip (SoC).

In some embodiments, processor(s) 112 includes the primary processor of machine learning server 110, controlling and coordinating operations of other system components. In some embodiments, the processor(s) 112 issues commands that control the operation of PPUs. In some embodiments, communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of CPUs 202, and the number of parallel processing subsystems 212, may be modified as desired. For example, in some embodiments, system memory 114 could be connected to the processor(s) 112 directly rather than through memory bridge 205, and other devices may communicate with system memory 114 via memory bridge 205 and processor 112. In other embodiments, parallel processing subsystem 212 may be connected to I/O bridge 207 or directly to processor 112, rather than to memory bridge 205. In still other embodiments, I/O bridge 207 and memory bridge 205 may be integrated into a single chip instead of existing as one or more discrete devices. In certain embodiments, one or more components shown in FIG. 2 may not be present. For example, switch 216 could be eliminated, and network adapter 218 and add-in cards 220, 221 would connect directly to I/O bridge 207. Lastly, in certain embodiments, one or more components shown in FIG. 2 may be implemented as virtualized resources in a virtual computing environment, such as a cloud computing environment. In particular, the parallel processing subsystem 212 may be implemented as a virtualized parallel processing subsystem in at least one embodiment. For example, the parallel processing subsystem 212 may be implemented as a virtual graphics processing unit(s) (vGPU(s)) that renders graphics on a virtual machine(s) (VM(s)) executing on a server machine(s) whose GPU(s) and other physical resources are shared across one or more VMs.

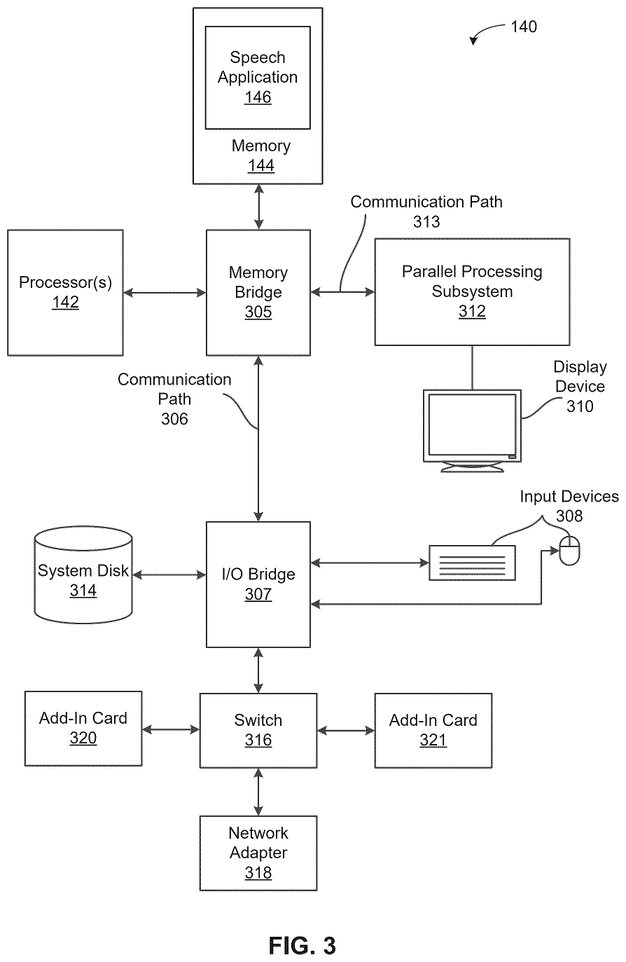

FIG. 3 is a block diagram illustrating the computing device 140 of FIG. 1 in greater detail, according to various embodiments. The computing device 140 may include any type of computing system, including, without limitation, a server machine, a server platform, a desktop machine, a laptop machine, a hand-held/mobile device, a digital kiosk, an in-vehicle infotainment system, and/or a wearable device. In some embodiments, the computing device 140 is a server machine operating in a data center or a cloud computing environment that provides scalable computing resources as a service over a network.

In various embodiments, the computing device 140 includes, without limitation, the processor(s) 142 and the memory (ies) 144 coupled to a parallel processing subsystem 312 via a memory bridge 305 and a communication path 313. Memory bridge 305 is further coupled to an I/O (input/output) bridge 307 via a communication path 306, and I/O bridge 307 is, in turn, coupled to a switch 316.

In one embodiment, I/O bridge 307 is configured to receive user input information from optional input devices 308, such as a keyboard, mouse, touch screen, sensor data analysis (e.g., evaluating gestures, speech, or other information about one or more uses in a field of view or sensory field of one or more sensors), and/or the like, and forward the input information to the processor(s) 142 for processing. In some embodiments, the computing device 140 may be a server machine in a cloud computing environment. In such embodiments, computing device 140 may not include input devices 308, but may receive equivalent input information by receiving commands (e.g., responsive to one or more inputs from a remote computing device) in the form of messages transmitted over a network and received via the network adapter 318. In some embodiments, switch 316 is configured to provide connections between I/O bridge 307 and other components of the computing device 140, such as a network adapter 318 and various add-in cards 320 and 321.

In some embodiments, I/O bridge 307 is coupled to a system disk 314 that may be configured to store content and applications and data for use by processor(s) 142 and parallel processing subsystem 312. In one embodiment, system disk 314 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 307 as well.

In various embodiments, memory bridge 305 may be a Northbridge chip, and I/O bridge 307 may be a Southbridge chip. In addition, communication paths 306 and 313, as well as other communication paths within computing device 140, may be implemented using any technically suitable protocols, including, without limitation, AGP (Accelerated Graphics Port), HyperTransport, or any other bus or point-to-point communication protocol known in the art.

In some embodiments, parallel processing subsystem 312 comprises a graphics subsystem that delivers pixels to an optional display device 310 that may be any conventional cathode ray tube, liquid crystal display, light-emitting diode display, and/or the like. In such embodiments, the parallel processing subsystem 312 may incorporate circuitry optimized for graphics and video processing, including, for example, video output circuitry. Such circuitry may be incorporated across one or more parallel processing units (PPUs), also referred to herein as parallel processors, included within the parallel processing subsystem 312.

In some embodiments, the parallel processing subsystem 312 incorporates circuitry optimized (e.g., that undergoes optimization) for general purpose and/or compute processing. Again, such circuitry may be incorporated across one or more PPUs included within parallel processing subsystem 312 that are configured to perform such general purpose and/or compute operations. In yet other embodiments, the one or more PPUs included within parallel processing subsystem 312 may be configured to perform graphics processing, general purpose processing, and/or compute processing operations. System memory 144 includes at least one device driver configured to manage the processing operations of the one or more PPUs within parallel processing subsystem 312. In addition, the system memory 144 includes the speech application 146. Although described herein primarily with respect to the speech application 146, techniques disclosed herein can also be implemented, either entirely or in part, in other software and/or hardware, such as in the parallel processing subsystem 312.

In various embodiments, parallel processing subsystem 312 may be integrated with one or more of the other elements of FIG. 3 to form a single system. For example, parallel processing subsystem 312 may be integrated with processor 142 and other connection circuitry on a single chip to form a system on a chip (SoC).

In some embodiments, processor(s) 142 includes the primary processor of computing device 140, controlling and coordinating operations of other system components. In some embodiments, the processor(s) 142 issues commands that control the operation of PPUs. In some embodiments, communication path 313 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of CPUs 302, and the number of parallel processing subsystems 312, may be modified as desired. For example, in some embodiments, system memory 144 could be connected to the processor(s) 142 directly rather than through memory bridge 305, and other devices may communicate with system memory 144 via memory bridge 305 and processor 142. In other embodiments, parallel processing subsystem 312 may be connected to I/O bridge 307 or directly to processor 142, rather than to memory bridge 305. In still other embodiments, I/O bridge 307 and memory bridge 305 may be integrated into a single chip instead of existing as one or more discrete devices. In certain embodiments, one or more components shown in FIG. 3 may not be present. For example, switch 316 could be eliminated, and network adapter 318 and add-in cards 320, 321 would connect directly to I/O bridge 307. Lastly, in certain embodiments, one or more components shown in FIG. 3 may be implemented as virtualized resources in a virtual computing environment, such as a cloud computing environment. In particular, the parallel processing subsystem 312 may be implemented as a virtualized parallel processing subsystem in at least one embodiment. For example, the parallel processing subsystem 312 may be implemented as a virtual graphics processing unit(s) (vGPU(s)) that renders graphics on a virtual machine(s) (VM(s)) executing on a server machine(s) whose GPU(s) and other physical resources are shared across one or more VMs.

### Enhancing Speech Language Models Using Descriptive Speech Text Alignment

FIG. 4 is a more detailed illustration of the model trainer 116 of FIG. 1, according to various embodiments. As shown, the model trainer 116 includes, without limitation, a speech caption generator 406, a descriptive speech-text alignment module 408, and an instruction-tuning module 410.

In operation, the model trainer 116 receives as inputs a pre-trained speech model 402, a language model 404, speech audio 414, speech meta information associated with the speech audio 414, and question-answer data 416. The speech caption generator 406 applies a template to the speech audio 414 and associated speech meta information 412 to generate natural language sentences. The speech caption generator 406 also prompts a trained language model (not shown) to generate speech captions based on the sentences.

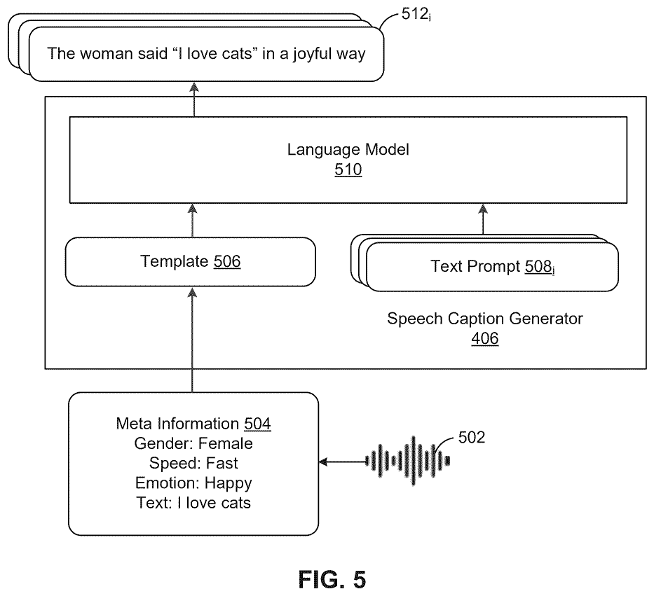

FIG. 5 is a more detailed illustration of the speech caption generator 406 of FIG. 4, according to various embodiments. As shown, the speech caption generator 406 includes, without limitation, a trained language model 510. Given meta information 504 corresponding to speech audio 502, the speech caption generator 406 applies a template 506 to the meta information 504 to generate a natural language sentence (not shown), which is input along with text prompts 508ᵢ (referred to herein collectively as text prompts 508 and individually as a text prompt 508) to generate speech captions 512ᵢ (referred to herein collectively as speech captions 512 and individually as a speech caption 512).

In some embodiments, the meta information 504 can specify attributes such as speaking style (e.g., pitch, volume, and speaking speed), speaker information (e.g., gender), and the actual spoken content. The meta information 504 can be obtained in any technically feasible manner in some embodiments. For example, some well-known data sets include meta information in addition to speech audio. As another example, in some embodiments, the model trainer 116 or another application can generate the meta information 504 from the speech audio using, for example, trained classification models.

The template 506 is used to convert the meta information 504 into a natural language sentence. For example, the template 506 could have the format: “A [gender] speaker says [text] with [emotion] emotion at [speed] speed.” In such cases, the speech caption generator 406 can fill in the [gender], [text], [emotion], and [speed] with corresponding data from the meta information 504. Although one template 506 is shown for illustrative purposes, multiple templates can be used in some embodiments.

The speech caption generator 406 inputs (1) the natural language sentence generated using the template 506, and (2) the text prompts 508 into the trained language model 510, which outputs the speech captions 512. Any technically feasible language model 510, such as a large language model (LLM), can be used in some embodiments. Inputs into the trained language model 510, such as the natural language sentence along with a text prompt 508, can be included in a context that is input into the trained language model 510. The text prompts 508 include different natural language text instructions that ask the trained language model 510 to generate the speech captions 512. In some embodiments, the text prompts 508 can be selected through prompt engineering to cause the trained language model 510 to generate diverse speech captions 512 that describe the meta information 504 in different ways but with the same meaning, while avoiding hallucinations. For example, in some embodiments, the text prompts 508 can instruct the trained language model 510 to accurately reflect the original spoken content while creatively incorporating speech attributes to avoid hallucination. In some embodiments, multiple speech captions can be generated using different templates and prompts to help ensure the training dataset represents a wide range of expressiveness while avoiding repetition.

Illustratively, the meta information 504 includes example data on the gender of the speaker, the speed of the speech, the emotion of the speech, and text of the speech audio 502. More specifically, in the speech audio 502, the gender of the speaker is female, the speed of the speech is fast, the emotion of the speech is happy, and the text is “I love cats.” Using the example template 506 described above, the speech caption generator 406 can convert the meta information 504 into the natural language sentence “A female speaker says I love cats with happy emotion at fast speed.” The speech caption generator 406 can then input, into the trained language model 510, the natural language sentence along with a text prompt 508 asking the trained language model 510 to re-phrase the natural language sentence. Illustratively, in response to receiving the natural language sentence and a text prompt 508 as input, the trained language model 510 outputs a speech caption 512 “The woman said ‘I love cats’ in a joyful way.” The other speech captions 512 can be generated in a similar manner by inputting the natural language sentence and the other text prompts 508 into the language model 510. That is, the speech caption generator 406 can repeatedly input, into the trained language model 510, the natural language sentence along with different text prompts 508 to generate multiple speech captions 512 that describe the meta information 504 associated with the speech audio 502 in different ways. Accordingly, speech-text pairs that include speech audio (e.g., speech audio 502) and speech captions (e.g., speech captions 512) can be generated for training the speech language model 150. Experience has shown that training the speech language model 150 using such training data can reduce the modality gap between the audio input of the speech audio 502 and the text input required by the trained language model 510. As described, the modality gap can cause conventional speech language models to misinterpret speech audio and generate incorrect or irrelevant responses to the speech audio whenever the speech audio cannot be accurately transcribed into text that language models in the conventional speech language models require as input.

Subsequent to generating the speech captions 512, the model trainer 116 trains the speech language model 150 in two stages, as shown in FIG. 4. Returning to FIG. 4, in a first stage of the training, the descriptive speech-text alignment module 408 trains the speech language model 150 that includes the pre-trained speech model 402 and the language model 404 using the speech audio 502, as well as the same text prompts 508 to generate the diverse captions and associated speech captions 512 (shown in FIG. 5) that were generated by the speech caption generator 406. Such training helps bridge the gap between the speech and text modalities, enabling the speech language model 150 to interpret and generate relatively comprehensive natural language descriptions that encapsulate the multi-dimensional aspects of speech, including the speaking style and speaker identity described above in conjunction with FIG. 5, thereby facilitating the capability to understand both linguistic and non-linguistic features in speech. Experience has shown that the trained speech language model 150 can perform better than conventional speech language models, particularly in generalizing to tasks for which the speech language model 150 was not explicitly trained. Moreover, the trained speech language model 150 can exhibit zero-shot instruction-following capability without explicit speech instruction tuning during training.

In some embodiments, during the first stage of training, the speech language model 150 can be trained to take as input the speech audio 414 and to output speech captions that match the speech captions generated by the language model 510 when the same text prompts 508 to generate the diverse captions are input into the language model 404 of the speech language model 150. Any technically feasible training, such as backpropagation with gradient descent or a variation thereof, can be performed by the model trainer 116 to train the speech language model 150 during the first stage. In some embodiments, the speech language model 150 is trained to generate speech captions with a next-token-prediction loss. In some embodiments, the speech language model 150 can have the architecture discussed below in conjunction with FIG. 6. In such cases, some portions of the speech language model 150 can remain fixed, while other parameters are updated, during the training. The first stage of training leverages speech captioning to bridge the gap between the speech and text modalities, enabling the speech language model 150 to interpret and generate comprehensive natural language descriptions, thereby facilitating the capability to understand both linguistic and non-linguistic features in speech (e.g., emotion, gender, pitch, etc.).

In a second stage of the training, the instruction tuning module 410 trains the speech language model 150 using question-answer data 416. The question-answer data 416 includes speech audio of users asking questions, as well as natural language text responses to the questions. In some embodiments, the question-answer data 416 include a wide range of instruction-guided speech processing tasks, which can be categorized into categories such as content (CON), semantic (SEM), paralinguistic (PAR), degradation (DEG), and speaker (SPK). In some embodiments, the speech language model 150 is trained to take as input speech audio in the question-answer data 416 and to output responses to the speech audio 414 that match the answers in the question-answer data 416, which are used as the expected output of the speech language model 150. Once again, any technically feasible training, such as backpropagation with gradient descent or a variation thereof that minimizes a next-token-prediction loss, can be performed by the model trainer 116 to train the speech language model 150 using the question-answer data 416 as training data.

FIG. 6 is a more detailed illustration of the speech application 146 of FIG. 1, according to various embodiments. As shown, the speech application 146 includes, without limitation, the speech language model 150. The speech language model 150 includes, without limitation, an encoder 604, a decoder 608, a modality adapter 606, and the language model 404 that includes LoRA (Low-Rank Adaptation of Large Language Models) adapters 618. In some embodiments, the encoder 604 and the decoder 608 are included in a pre-trained speech model, such as a pre-trained speech model having a transformer architecture. For example, the pre-trained speech model could be the pre-trained speech model 402 described above in conjunction with FIG. 4. Any technically feasible language model 404 and pre-trained speech model can be used in some embodiments, such as well-known LLMs that are trained to follow instructions and speech models.

In operation, the speech application 146 receives as input speech audio 602. For example, the speech audio 602 can include audio of a speaker asking a question. Although described herein primarily with respect to questions and answers to the questions as a reference example, any suitable audio input that includes speech and text output can be used in some embodiments. The speech application 146 processes the speech audio 602 using the speech language model 150. Illustratively, after the speech application 146 inputs the speech audio 602 into the speech language model 150, the encoder 604 encodes the speech audio 602 to generate a latent representation (not shown) of the speech audio 602, which can be a vector of numbers in some embodiments.

The latent representation generated by the encoder 604 is input into the modality adapter 606, which generates speech features 610, and the decoder 608, which generates a natural language text transcription 612 of the speech. In some embodiments, the speech features 610 can include a latent vector of values corresponding to meta information, such as speaking style (e.g., pitch volume, and speaking speed) and speaker information (e.g., gender). The modality adapter 606 learns to generate such speech features based on speech captions during the first phase of training, described above in conjunction with FIG. 5. The modality adapter 606 is designed to extract meaningful representations from speech inputs. In some embodiments, the modality adapter 606 processes the hidden inputs from the intermediate layers of the encoder 604 to obtain high-level speech features. In such cases, the layer-wise representation can also be combined through a weighted summation using learnable weights to obtain a final representation, and a projection layer can be employed to map the final representations into an embedding space of the language model 404. Any technically feasible architecture of the modality adapter 606 can be used in some embodiments. For example, in some embodiments, the modality adapter 606 can include a querying transformer (Qformer), a convolutional neural network (CNN), or the like.

The speech features 610, the transcription 612, and a text prompt 614 are then input into the language model 404. In some embodiments, the speech features 610, the transcription 612, and the text prompt 614 are concatenated together for input into the language model 404. Any suitable text prompt 614, such as a prompt asking the language model 404 to answer the question in the transcription 612, can be used in some embodiments. Given the speech features 610, the transcription 612, and the text prompt 614, the language model 404 outputs a natural language response 620. For example, the response 620 can include an answer to a question in the speech audio 602.

In some embodiments, the encoder 604, the decoder 608, and the language model 404 are fixed during the two-stage training described above in conjunction with FIG. 5, while parameters of the modality adapter 606 and the LoRA adapters 618 are updated during the two-stage training. The LoRA adapters 618 are used to fine-tune the language model 404 relatively efficiently, without updating parameters of the language model 404. In some embodiments, the LoRA adapters 618 (rank=32) are injected into the query, key, and value projection layers of an attention mechanisms within the language model 404. In such cases, a scaling factor a can be set to control the impact of the LoRA adapters 618 at inference time. In some embodiments, LoRA adapters may not be used. In such cases, parameters of the language model 404 can be updated during training.

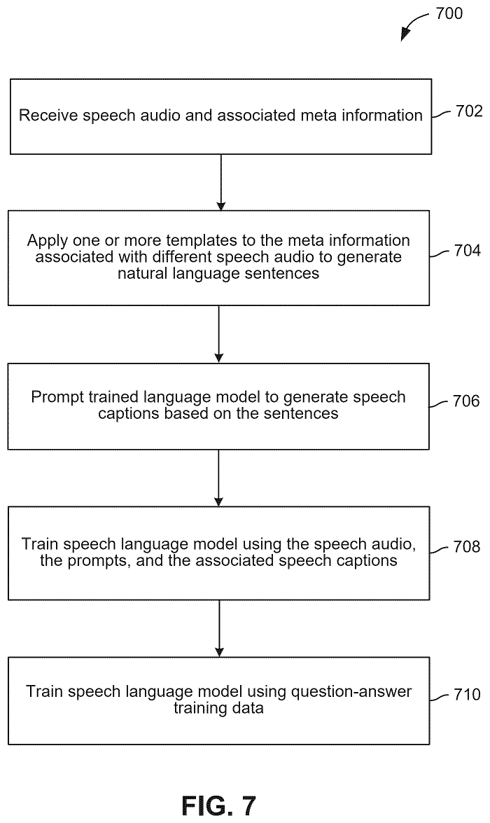

FIG. 7 is a flow diagram of method steps for training the speech language model 150, according to various embodiments. Although the method steps are described in conjunction with the systems of FIGS. 1-6, persons skilled in the art will understand that any system configured to perform the method steps in any order falls within the scope of the present embodiments.

As shown, a method 700 begins at step 702, where the model trainer 116 receives speech audio and associated meta information. As described, the meta information can be obtained in any suitable manner. For example, some well-known data sets include meta information in addition to speech audio. As another example, in some embodiments, the model trainer 116 or another application can generate the meta information from the speech audio using, e.g., trained classification models.

At step 704, the model trainer 116 applies one or more templates to the meta information associated with different speech audio to generate natural language sentences. As described, each template is used to convert the meta information 504 into a natural language sentence. For example, a template having format “A [gender] speaker says [text] with [emotion] emotion at [speed] speed,” could be filled in with [gender], [text], [emotion], and [speed] data from the meta information associated with different speech audio to generate corresponding natural language sentences.

At step 706, the model trainer 116 prompts the trained language model 510 to generate speech captions based on the sentences. Prompting the trained language model 510 can include inputting the sentences and text prompts into the trained language model 510. As described, in some embodiments, the text prompts include different natural language text instructions that ask the trained language model 510 to generate the speech captions, and the text prompts can be selected to cause the trained language model to generate diverse speech captions that describe the meta information in different ways but with the same meaning, while avoiding hallucinations. Further, in some embodiments, multiple speech captions can be generated using different templates and prompts to help ensure the training dataset represents a wide range of expressiveness while avoiding repetition.

At step 708, the model trainer 116 trains the speech language model 150 using the speech audio, the prompts, and the associated speech captions. As described, the speech language model 150 can be trained to take as input speech audio and to output speech captions that match the speech captions generated by the language model 510 when the same text prompts to generate the diverse captions are input into the language model 404 of the speech language model 150. In some embodiments, any technically feasible training can be performed, such as backpropagation with gradient descent or a variation thereof. In some embodiments, the speech language model 150 is trained using the speech audio, the prompts, and the associated speech captions to generate speech captions with a next-token-prediction loss. In some embodiments, the speech language model 150 includes the pre-trained speech model 402 and the trained language model 404 that are fixed during the training at step 708, as well as the modality adapter 606 and the LoRA adapters 618 in the trained language model 404, whose parameters are updated during the training. In such cases, the modality adapter 606 and the LoRA adapters 618 can be randomly initialized during the training.

At step 710, the model trainer 116 trains the speech language model 150 using question-answer training data. As described, the speech language model 150 is trained to take as input speech audio from the question-answer training data that includes users asking questions, and to output responses to the speech audio that match the answers in the question-answer training data. In some embodiments, any technically feasible training, such as backpropagation with gradient descent or a variation thereof that minimizes a next-token-prediction loss, can be performed to train the speech language model 150 using the question-answer training data. Similar to step 708, in some embodiments, the speech language model 150 includes the pre-trained speech model 402 and the trained language model 404 that are fixed during the training at step 710, as well as the modality adapter 606 and the LoRA adapters 618 in the trained language model 404, whose parameters are updated during the training.

FIG. 8 is a flow diagram of method steps for processing speech audio using the trained speech language model 150, according to various embodiments. Although the method steps are described in conjunction with the systems of FIGS. 1-6, persons skilled in the art will understand that any system configured to perform the method steps in any order falls within the scope of the present embodiments.

As shown, a method 800 begins at step 802, where the speech application 146 receives speech audio. For example, in some embodiments, the speech audio can include a speaker asking a question.

At step 804, the speech application 146 processes the speech audio using the encoder 604 of the trained speech language model 150 to generate a latent representation of the speech audio. As described, the encoder 604 can be part of the pre-trained speech model 402 in some embodiments.

At step 806, the speech application 146 processes the latent representation using the modality adapter 606 and the decoder 608 to generate speech features and a transcription of the speech audio, respectively. As described, in some embodiments, the decoder 608 can be part of the pre-trained speech model 402, while the modality adapter 606 can learn to generate speech features based on speech captions during a first phase of training of the speech language model 150. In some embodiments, the modality adapter 606 processes the hidden inputs from the intermediate layers of the encoder 604 to obtain high-level speech features. In such cases, the layer-wise representation can also be combined through a weighted summation using learnable weights to obtain a final representation, and a projection layer can be employed to map the final representations into an embedding space of the language model 404.

At step 808, the speech application 146 processes the speech features, transcription, and text prompt using the language model 404 of the trained speech language model 150 to generate a response. For example, the response can include natural language text answering a question from the input speech audio. As described, in some embodiments, the language model 404 includes LoRA adapters 618 that are injected into the query, key, and value projection layers of an attention mechanisms within the language model 404, and parameters of the LoRA adapters can be updated during training.

In sum, techniques are disclosed for training and using a speech language model to respond to audio of speech. In some embodiments, the speech language model includes a speech model that is trained to convert speech audio into natural language transcriptions, a language model that is trained to answer questions, and a modality adapter that is trained to generate speech features from a latent representation output by an encoder of the speech language model. Given speech audio as input, the encoder of the speech model encodes the speech audio to generate the latent representation. The latent representation is then input into the modality adapter, which generates the speech features, and a decoder of the speech model, which generates a natural language text transcription of the speech. The speech features, the transcription, and a text prompt (e.g., asking the language model to answer the question) are then input into the language model, which outputs a natural language response.

In some embodiments, the speech language model is trained in two stages. In a first stage of the training, the speech language model is trained using speech audio, as well as the text prompts and associated speech captions that are generated to describe meta information associated with the speech audio in different ways. Specifically, the speech language model is trained to take as input the speech audio and to output speech captions. In a second stage of the training, the speech language model is trained using question-answer data that includes speech audio of users asking questions and natural language text answers to the questions. Specifically, the speech language model is trained to take as input the speech audio and to output responses to the speech audio.

At least one technical advantage of the disclosed techniques relative to the prior art is that, with the disclosed techniques, a speech language model can be trained to account for context, such as the speed and emotional tone of speech and the gender of a speaker, in speech audio. By considering both the context of speech within the speech audio and the text that is transcribed from the speech audio, the disclosed techniques can mitigate the effects of the text being transcribed inaccurately. That is, even when the transcribed text is inaccurate due to complex or non-standard speech patterns that a speech model in the speech language model was not trained to understand, the speech language mode is able to generate more correct and relevant responses that adjust for the inaccuracies in the transcription. In particular, the disclosed techniques can generate more correct and relevant responses to speech audio than is possible with conventional speech language models that rely solely on the transcribed text. For example, the disclosed techniques can be used to generate answers to questions in speech audio that are more accurate than answers generated by conventional speech language models. These technical advantages represent one or more technological improvements over prior art approaches.
1. In some embodiments, a computer-implemented method for responding to audio input comprises processing the audio input using a trained encoder to generate a representation of the audio input, wherein the audio input includes speech, processing the representation of the audio input using a first trained adapter to generate one or more features, and processing the one or more features and text associated with the audio input using a trained language model to generate a response.
2. The computer-implemented method of clause 1, further comprising processing the representation of the audio input using a trained decoder to generate the text associated with the audio input.
3. The computer-implemented method of clauses 1 or 2, wherein the trained encoder and the trained decoder are included in a trained speech model.
4. The computer-implemented method of any of clauses 1-3, wherein the one or more features represent at least one of a speaking style or speaker information associated with the speech.
5. The computer-implemented method of any of clauses 1-4, wherein the one or more features represent at least one of a pitch, a volume, a speaking speed, an emotion, or a gender associated with the speech.
6. The computer-implemented method of any of clauses 1-5, wherein the trained language model comprises a second trained adapter, and the second trained adapter was trained together with the first trained adapter.
7. The computer-implemented method of any of clauses 1-6, wherein the second trained adapter comprises a trained Low-Rank Adaptation of Large Language Models (LoRA) adapter.
8. The computer-implemented method of any of clauses 1-7, wherein processing the one or more features and the text using the trained language model comprises prompting the trained language model to respond to the text.
9. The computer-implemented method of any of clauses 1-8, wherein the trained language model comprises a large language model (LLM).
10. The computer-implemented method of any of clauses 1-9, wherein the speech includes a question, and the response comprises text that includes an answer to the question.
11. In some embodiments, one or more non-transitory computer-readable media store instructions that, when executed by at least one processor, cause the at least one processor to perform the steps of processing audio input using a trained encoder to generate a representation of the audio input, wherein the audio input includes speech, processing the representation of the audio input using a first trained adapter to generate one or more features, and processing the one or more features and text associated with the audio input using a trained language model to generate a response.
12. The one or more non-transitory computer-readable media of clause 11, wherein the instructions, when executed by the at least one processor, further cause the at least one processor to perform the step of processing the representation of the audio input using a trained decoder to generate the text associated with the audio input.
13. The one or more non-transitory computer-readable media of clauses 11 or 12, wherein the first trained adapter is trained separately from the trained encoder and the trained language model.
14. The one or more non-transitory computer-readable media of any of clauses 11-13, wherein the one or more features represent at least one of a speaking style or speaker information associated with the speech.
15. The one or more non-transitory computer-readable media of any of clauses 11-14, wherein the one or more features represent at least one of a pitch, a volume, a speaking speed, an emotion, or a gender associated with the speech.
16. The one or more non-transitory computer-readable media of any of clauses 11-15, wherein the trained language model comprises a second trained adapter, and the second trained adapter was trained together with the first trained adapter.
17. The one or more non-transitory computer-readable media of any of clauses 11-16, wherein processing the one or more features and the text using the trained language model comprises prompting the trained language model to respond to the text.
18. The one or more non-transitory computer-readable media of any of clauses 11-17, wherein the speech includes a question, and the response comprises text that includes an answer to the question.
19. The one or more non-transitory computer-readable media of any of clauses 11-18, wherein the instructions, when executed by the at least one processor, further cause the at least one processor to perform the step of outputting the response via an output device.
20. In some embodiments, a system comprises one or more memories storing instructions, and one or more processors that are coupled to the one or more memories and, when executing the instructions, are configured to process audio input using a trained encoder to generate a representation of the audio input, wherein the audio input includes speech, process the representation of the audio input using a first trained adapter to generate one or more features, and process the one or more features and text associated with the audio input using a trained language model to generate a response.
1. In some embodiments, a computer-implemented method for training a speech language model comprises generating a set of text captions based on meta information associated with a first set of audio that includes speech, wherein the meta information specifies at least one of a speaking style or speaker information associated with the speech included in the first set of audio, and performing, using the first set of audio and the set of text captions, one or more first operations to train a speech language model to generate a text caption for first input audio that includes speech.
2. The computer-implemented method of clause 1, further comprising performing, using a second set of audio and expected text output corresponding to the second set of audio, one or more second operations to train the speech language model to generate a text response to second input audio that includes speech.
3. The computer-implemented method of clauses 1 or 2, wherein the second set of audio includes one or more questions, and the expected text output includes one or more answers to the one or more questions.
4. The computer-implemented method of any of clauses 1-3, wherein the meta information specifies at least one of a pitch, a volume, a speaking speed, a gender, or a spoken content associated with the speech included in the first set of audio.
5. The computer-implemented method of any of clauses 1-4, wherein generating the set of text captions comprises applying one or more templates to the meta information.
6. The computer-implemented method of any of clauses 1-5, wherein generating the set of text captions comprises processing one or more sentences that include the meta information and one or more text prompts using a trained language model that outputs the set of text captions.
7. The computer-implemented method of any of clauses 1-6, wherein the one or more text prompts instruct the trained language model to generate the set of text captions to (i) reflect spoken content of the speech included in the first set of audio, and (ii) describe one or more attributes of the first set of audio that are specified by the meta information.
8. The computer-implemented method of any of clauses 1-7, wherein the speech language model comprises an encoder that encodes the first input audio to generate a representation of the first input audio, a decoder that decodes the representation of the first input audio to generate a text transcription, an adapter that decodes the representation of the first input audio to generate one or more features, and a language model that processes the text transcription, the one or more features, and a text prompt to generate an output text.
9. The computer-implemented method of any of clauses 1-8, wherein the one or more first operations update one or more parameters of the adapter.
10. The computer-implemented method of any of clauses 1-9, wherein the language model comprises one or more LoRA (Low-Rank Adaptation of Large Language Models) adapters.
11. In some embodiments, one or more non-transitory computer-readable media store instructions that, when executed by at least one processor, cause the at least one processor to perform the steps of generating a set of text captions based on meta information associated with a first set of audio that includes speech, wherein the meta information specifies at least one of a speaking style or a speaker information associated with the speech included in the first set of audio, and performing, using the first set of audio and the set of text captions, one or more first operations to train a speech language model to generate a text caption for first input audio that includes speech.
12. The one or more non-transitory computer-readable media of clause 11, wherein the instructions, when executed by the at least one processor, further cause the at least one processor to perform the step of performing, using a second set of audio and expected text output corresponding to the second set of audio, one or more second operations to train the speech language model to generate a text response to second input audio that includes speech.
13. The one or more non-transitory computer-readable media of clauses 11 or 12, wherein the instructions, when executed by the at least one processor, further cause the at least one processor to perform the step of, subsequent to performing the one or more second operations to train the speech language model, processing third input audio using the speech language model to generate a text response to the third input audio.
14. The one or more non-transitory computer-readable media of any of clauses 11-13, wherein the meta information specifies at least one of a pitch, a volume, a speaking speed, a gender, or a spoken content associated with the speech included in the first set of audio.
15. The one or more non-transitory computer-readable media of any of clauses 11-14, wherein generating the set of text captions comprises applying one or more templates to the meta information to generate one or more sentences, and processing the one or more sentences and one or more text prompts using a trained language model to generate the set of text captions.
16. The one or more non-transitory computer-readable media of any of clauses 11-15, wherein the one or more text prompts instruct the trained language model to generate the set of text captions to (i) reflect spoken content of the speech included in the first set of audio and (ii) describe one or more attributes of the first set of audio that are specified by the meta information.
17. The one or more non-transitory computer-readable media of any of clauses 11-16, wherein the trained language model comprises a trained large language model (LLM).
18. The one or more non-transitory computer-readable media of any of clauses 11-17, wherein the speech language model comprises an encoder that encodes the first input audio to generate a representation of the first input audio, a decoder that decodes the representation of the first input audio to generate a text transcription, an adapter that decodes the representation of the first input audio to generate one or more features, and a language model that processes the text transcription, the one or more features, and a text prompt to generate an output text.
19. The one or more non-transitory computer-readable media of any of clauses 11-18, wherein the one or more first operations update one or more parameters of the adapter.
20. In some embodiments, a system comprises one or more memories storing instructions, and one or more processors that are coupled to the one or more memories and, when executing the instructions, are configured to generate a set of text captions based on meta information associated with a first set of audio that includes speech, wherein the meta information specifies at least one of a speaking style or a speaker information associated with the speech included in the first set of audio, and perform, using the first set of audio and the set of text captions, one or more operations to train a speech language model to generate a text caption for input audio that includes speech.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for training a speech language model, the method comprising:
generating a set of text captions based on meta information associated with a first set of audio that includes speech, wherein the meta information specifies at least one of a speaking style or speaker information associated with the speech included in the first set of audio; and
performing, using the first set of audio and the set of text captions, one or more first operations to train a speech language model to generate a text caption for first input audio that includes speech.

2. The computer-implemented method of claim 1, further comprising performing, using a second set of audio and expected text output corresponding to the second set of audio, one or more second operations to train the speech language model to generate a text response to second input audio that includes speech.

3. The computer-implemented method of claim 2, wherein the second set of audio includes one or more questions, and the expected text output includes one or more answers to the one or more questions.

4. The computer-implemented method of claim 1, wherein the meta information specifies at least one of a pitch, a volume, a speaking speed, a gender, or a spoken content associated with the speech included in the first set of audio.

5. The computer-implemented method of claim 1, wherein generating the set of text captions comprises applying one or more templates to the meta information.

6. The computer-implemented method of claim 1, wherein generating the set of text captions comprises processing one or more sentences that include the meta information and one or more text prompts using a trained language model that outputs the set of text captions.

7. The computer-implemented method of claim 6, wherein the one or more text prompts instruct the trained language model to generate the set of text captions to (i) reflect spoken content of the speech included in the first set of audio, and (ii) describe one or more attributes of the first set of audio that are specified by the meta information.

8. The computer-implemented method of claim 1, wherein the speech language model comprises:
an encoder that encodes the first input audio to generate a representation of the first input audio;
a decoder that decodes the representation of the first input audio to generate a text transcription;
an adapter that decodes the representation of the first input audio to generate one or more features; and
a language model that processes the text transcription, the one or more features, and a text prompt to generate an output text.

9. The computer-implemented method of claim 8, wherein the one or more first operations update one or more parameters of the adapter.

10. The computer-implemented method of claim 8, wherein the language model comprises one or more LoRA (Low-Rank Adaptation of Large Language Models) adapters.

11. One or more non-transitory computer-readable media storing instructions that, when executed by at least one processor, cause the at least one processor to perform the steps of:
generating a set of text captions based on meta information associated with a first set of audio that includes speech, wherein the meta information specifies at least one of a speaking style or a speaker information associated with the speech included in the first set of audio; and
performing, using the first set of audio and the set of text captions, one or more first operations to train a speech language model to generate a text caption for first input audio that includes speech.

12. The one or more non-transitory computer-readable media of claim 11, wherein the instructions, when executed by the at least one processor, further cause the at least one processor to perform the step of performing, using a second set of audio and expected text output corresponding to the second set of audio, one or more second operations to train the speech language model to generate a text response to second input audio that includes speech.

13. The one or more non-transitory computer-readable media of claim 12, wherein the instructions, when executed by the at least one processor, further cause the at least one processor to perform the step of, subsequent to performing the one or more second operations to train the speech language model, processing third input audio using the speech language model to generate a text response to the third input audio.

14. The one or more non-transitory computer-readable media of claim 11, wherein the meta information specifies at least one of a pitch, a volume, a speaking speed, a gender, or a spoken content associated with the speech included in the first set of audio.

15. The one or more non-transitory computer-readable media of claim 11, wherein generating the set of text captions comprises:
applying one or more templates to the meta information to generate one or more sentences; and
processing the one or more sentences and one or more text prompts using a trained language model to generate the set of text captions.

16. The one or more non-transitory computer-readable media of claim 15, wherein the one or more text prompts instruct the trained language model to generate the set of text captions to (i) reflect spoken content of the speech included in the first set of audio and (ii) describe one or more attributes of the first set of audio that are specified by the meta information.

17. The one or more non-transitory computer-readable media of claim 16, wherein the trained language model comprises a trained large language model (LLM).

18. The one or more non-transitory computer-readable media of claim 11, wherein the speech language model comprises:
an encoder that encodes the first input audio to generate a representation of the first input audio;
a decoder that decodes the representation of the first input audio to generate a text transcription;
an adapter that decodes the representation of the first input audio to generate one or more features; and
a language model that processes the text transcription, the one or more features, and a text prompt to generate an output text.

19. The one or more non-transitory computer-readable media of claim 18, wherein the one or more first operations update one or more parameters of the adapter.

20. A system, comprising:
one or more memories storing instructions; and
one or more processors that are coupled to the one or more memories and, when executing the instructions, are configured to:
generate a set of text captions based on meta information associated with a first set of audio that includes speech, wherein the meta information specifies at least one of a speaking style or a speaker information associated with the speech included in the first set of audio, and
perform, using the first set of audio and the set of text captions, one or more operations to train a speech language model to generate a text caption for input audio that includes speech.
